(19) United States
(12) Patent Application Publication
(10) Pub. No.: US 2026/0074331 A1
(43) Pub. Date: Mar. 12, 2026

(54) SECONDARY BATTERY

(71) Applicant: SAMSUNG SDI CO., LTD., Yongin-si (KR)

(72) Inventor: Dong Bok YANG, Yongin-si (KR)

(21) Appl. No.: 19/182,821

(22) Filed: Apr. 18, 2025

(30) Foreign Application Priority Data
Sep. 6, 2024 (KR) 10-2024-0121375

(51) Int. Cl. H01M 50/184; B60L 50/64; H01M 50/105; H01M 50/538

(52) U.S. Cl. CPC H01M 50/184; H01M 50/105; H01M 50/538; B60L 50/64; H01M 2220/20

(57) ABSTRACT

A secondary battery includes a case including an accommodation part and a cap part, the accommodation part and the cap part being bonded by a sealing layer that includes a first sealing layer and a second sealing layer, and a melting temperature of the second sealing layer being lower than a melting temperature of the first sealing layer, an electrode assembly accommodated in the accommodation part, a plurality of electrode tabs connected to the electrode assembly, and a plurality of leads connected to the electrode tabs.

### CROSS-REFERENCE TO THE RELATED APPLICATION

The present application claims priority to and the benefit of Korean Patent Application No. 10-2024-0121375, filed on Sep. 6, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

A secondary battery includes a case including an accommodation part and a cap part, an electrode assembly accommodated in the accommodation part, a plurality of electrode tabs connected to the electrode assembly, and a plurality of leads connected to the electrode tabs, the accommodation part and the cap part are bonded by a sealing layer disposed in a sealing region, the sealing layer includes a plurality of sealing parts disposed on the sealing region, at least one sealing part includes a first sealing layer and a second sealing layer, and a melting temperature of the second sealing layer is lower than a melting temperature of the first sealing layer.

The sealing part may include a first sealing part, a second sealing part, and a third sealing part, the lead is disposed on the first sealing part, and at least one of the second sealing part or the third sealing part includes the first sealing layer and the second sealing layer.

The case may include a convex part, and the convex part is arranged on a region corresponding to the second sealing layer.

The sealing part may include a first sealing part, a second sealing part, and a third sealing part, the lead is disposed on the first sealing part, and the first sealing part includes the first sealing layer and the second sealing layer.

The second sealing layer may be disposed between the plurality of leads.

The second sealing layer may be disposed in the entire region between the leads.

The second sealing layer may be disposed in a portion of the region between the leads.

The first sealing layer and the second sealing layer may be formed in different methods.

The second sealing layer may include a sealing film

The melting temperature of the first sealing layer may be 130° C. to 140° C., and the melting temperature of the second sealing layer may be 90° C. to 110° C.

The first sealing layer and the second sealing layer may include the same material.

The first sealing layer and the second sealing layer may include different materials.

A secondary battery includes a case including an accommodation part and a cap part, an electrode assembly accommodated in the accommodation part, a plurality of electrode tabs connected to the electrode assembly, and a plurality of leads connected to the electrode tabs, the accommodation part and the cap part are bonded by a sealing layer disposed in a sealing region, the sealing layer includes a plurality of sealing parts disposed in the sealing region, and at least one of the sealing parts includes the sealing layers having different thickness.

The sealing part may include a first sealing part, a second sealing part, and a third sealing part, the lead is disposed on the first sealing part, and at least one of the second sealing part or the third sealing part includes the sealing layers having a different thickness.

The second sealing part may include the sealing layer having a first thickness, the third sealing part includes the sealing layer having a first thickness and the sealing layer having a second thickness, and the second thickness is smaller than the first thickness.

A secondary battery includes a case including an accommodation part and a cap part, an electrode assembly accommodated in the accommodation part, a plurality of electrode tabs connected to the electrode assembly, and a plurality of leads connected to the electrode tabs, the accommodation part and the cap part are bonded by a sealing layer disposed in a sealing region, the sealing layer includes a plurality of sealing parts disposed on the sealing region, and at least one sealing part includes the sealing layer smaller than the width of the sealing region.

The sealing part may include a first sealing part, a second sealing part, and a third sealing part, the lead is disposed on the first sealing part, and at least one of the second sealing part or the third sealing part includes the sealing layer including regions having different widths.

At least one of the second sealing part or the third sealing part may include the sealing layer including a region having a first width and a region having a second width, and the second width is smaller than the first width.

The sealing layer having the second width may be disposed in a central region or an edge region of the sealing region.

The sealing part may include a first sealing part, a second sealing part, and a third sealing part, the lead is disposed on the first sealing part, at least one of the second sealing part or the third sealing part includes the sealing layer disposed in an edge region of the sealing region, and a width of the sealing layer is 50% or more of the width of the sealing region.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a secondary battery according to an embodiment.

FIG. 2 is a top view showing a secondary battery according to an embodiment.

FIG. 3 is a sectional view taken along line A-A′ of FIG. 2.

FIG. 4 is an enlarged view showing region A of FIG. 3.

FIG. 5 is another top view showing a secondary battery according to an embodiment.

FIG. 6 is a top view showing a lead of a secondary battery according to an embodiment.

FIG. 7 is a sectional view taken along line B-B′ of FIG. 5.

FIGS. 8 and 9 are enlarged views showing region B of FIG. 7.

FIG. 10 is another top view showing a secondary battery according to an embodiment.

FIG. 11 is a sectional view taken along line C-C′ of FIG. 10.

FIG. 12 is a sectional view taken along line D-D′ of FIG. 10.

FIG. 13 is another top view showing a secondary battery according to an embodiment.

FIGS. 14 to 18 are views explaining a sealing layer on a region C of FIG. 13.

FIG. 19 is another top view showing a secondary battery according to an embodiment.

FIG. 20 is a view explaining a sealing layer on a region D of FIG. 19.

FIGS. 21 and 22 are perspective views showing a battery pack including battery modules according to some embodiments.

FIGS. 23 and 24 are perspective views and a side view showing a vehicle including battery packs according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to an embodiment will be described with reference to the drawings. The secondary battery may be classified into, e.g., a cylindrical shape, a prismatic shape, a pouch shape, or a coin shape depending on the shape. The secondary battery described below may be applied to a pouch secondary battery. Hereinafter, the pouch secondary battery is mainly described.

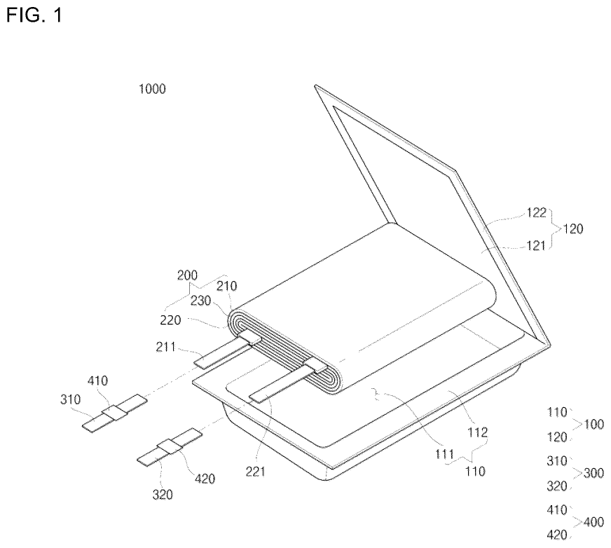

FIG. 1 is a perspective view showing a secondary battery 1000 according to an embodiment.

Referring to FIG. 1, the secondary battery 1000 according to an embodiment may include a case 100 and an electrode assembly 200.

The case 100 may include an accommodation part 110 and a cap part 120. The accommodation part 110 and the cap part 120 may be connected. The accommodation part 110 and the cap part 120 may be formed integrally. The case 100 may be formed in a pouch shape.

The accommodation part 110 may include a concave part 111 and a first sealing region 112. The accommodation part 110 may include an accommodation space. In detail, the accommodation part 110 may include an internal bottom surface and an inner side surface formed by the concave part 111. The accommodation space may be formed by the bottom surface and the inner side surface.

The first sealing region 112 may be disposed at the edge of the accommodation part 110. A sealing layer may be disposed on the first sealing region 112.

The cap part 120 may include a cover part 121 and a second sealing region 122.

The cover part 121 may cover the accommodation part 110. In detail, the cover part 121 may cover the electrode assembly 200 accommodated in the accommodation part 110.

The second sealing region 122 may be disposed at the edge of the cap part 120. A sealing layer may be disposed on the second sealing region 122. The first sealing region 112 and the second sealing region 122 may overlap. In detail, when the accommodation part 110 is covered by the cap part 120, the first sealing region 112 and the second sealing region 122 may face each other. Accordingly, the case 100 may be bonded by the sealing regions 112 and 122. Accordingly, the electrode assembly 200 may be sealed in the case 100.

The electrode assembly 200 may be accommodated in the case 100. In detail, the electrode assembly 200 may be accommodated in the accommodation space of the case 100. In detail, the electrode assembly 200 may be accommodated in the accommodation space together with an electrolyte.

In the drawing, one electrode assembly 200 is accommodated in the case 100. However, two or more electrode assemblies may be accommodated in the case 100.

The electrode assembly 200 may include a first electrode 210, a second electrode 220, and a separator 230. For example, the electrode assembly 200 may be formed by winding or laminating the first electrode 210, the second electrode 220, and the separator 230. When the electrode assembly 200 has a winding shape, the winding axis may be parallel to the longitudinal direction of the case. In another example, the electrode assembly may be a Z-stack electrode assembly in which the first electrode 210 and the second electrode 220 are inserted on both sides of the separator 230 that is bent into a Z-stack.

The first electrode 210 may include a first electrode current collector and a first electrode active material layer on the first electrode current collector. The first electrode current collector may include a metal foil such as aluminum or an aluminum alloy. The first electrode active material layer may include a transition metal oxide. For example, the first electrode 210 may be a positive electrode.

The first electrode 210 may include a first electrode tab 211. The first electrode active material layer is not disposed on the first electrode tab 211. For example, the first electrode tab 211 may be welded to the first electrode current collector. In another example, the first electrode tab 211 may be formed integrally with the first electrode current collector. For example, the first electrode current collector may include a first uncoated portion on which the first electrode active material layer is not disposed. The first uncoated portion may be the first electrode tab 211. The first electrode tab 211 may include the same material as the first electrode current collector.

The second electrode 220 may include a second electrode current collector and a second electrode active material layer on the second electrode current collector. The second electrode current collector may include a metal foil such as copper, a copper alloy, nickel, or a nickel alloy. The second electrode active material layer may include graphite or carbon. For example, the second electrode 220 may be a negative electrode.

The second electrode 220 may include a second electrode tab 221. The second electrode active material layer is not disposed on the second electrode tab 221. For example, the second electrode tab 221 may be welded to the second electrode current collector. In another example, the second electrode tab 221 may be formed integrally with the second electrode current collector. For example, the second electrode current collector may include a second uncoated portion on which the second electrode active material layer is not disposed. The second uncoated portion may be the second electrode tab 221. The second electrode tab 221 may include the same material as the second electrode current collector.

The first electrode tab 211 and the second electrode tab 221 may be disposed in the accommodation space. To this end, the first electrode tab 211 and the second electrode tab 221 may be bent at least once.

The first electrode tab 211 and the second electrode tab 221 may each be connected to a lead. For example, the first electrode tab 211 may be connected to a first lead 310. The first electrode tab 211 may be connected to a first external terminal by the first lead 310. The second electrode tab 221 may be connected to a second lead 320. The second electrode tab 221 may be connected to a second external terminal by the second lead 320. The first lead 310 may include the same material as the first electrode tab 211, and the second lead 320 may include the same material as the second electrode tab 221.

A first insulating layer 410 may be disposed on the first lead 310. The first insulating layer 410 may surround the first lead 310. Therefore, the first lead 310 may be insulated from the case 100 by the first insulating layer 410, and the first lead 310 and the case 100, which include different materials, may be easily bonded by the first insulating layer 410. That is, the first insulating layer 410 may be a buffer layer or an adhesive layer.

A second insulating layer 420 may be disposed on the second lead 320. The second insulating layer 420 may surround the second lead 320. Accordingly, the second lead 320 may be insulated from the case 100 by the second insulating layer 420, and the second lead 320 and the case 100, which include different materials, may be easily bonded by the second insulating layer 420. That is, the second insulating layer 420 may be a buffer layer or an adhesive layer.

The internal temperature of a secondary battery may potentially increase due to overcharge or malfunction. If the secondary battery is exposed to a high temperature environment for a long time, gas may be generated in the electrode assembly, and the pressure in the secondary battery may increase due to the gas.

The sealing layer in the case of the secondary battery may include a resin material. The melting point of the sealing layer and the melting point of the electrolyte may be different. In general, the melting point of the sealing layer may be higher than the melting point of the electrolyte. Accordingly, gas may be generated as the electrolyte vaporizes first, thereby increasing the internal pressure due to the gas. If the temperature of the secondary battery further increases, the sealing layer may melt and a vent may be formed, thereby releasing gas through the formed vent. However, if the pressure in the secondary battery increases rapidly before the vent is opened, the secondary battery may explode due to the increase in internal temperature before the vent is formed.

In contrast, a secondary battery, according to example embodiment, may control the sealing layer that adheres the accommodation part and the cap part, thereby improving safety of the secondary battery.

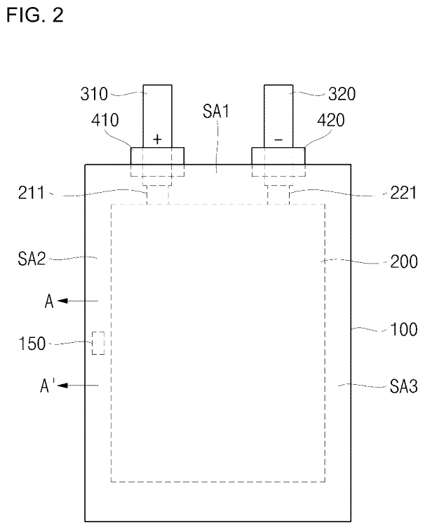

Hereinafter, secondary batteries of various embodiments will be described with reference to FIGS. 2-4.

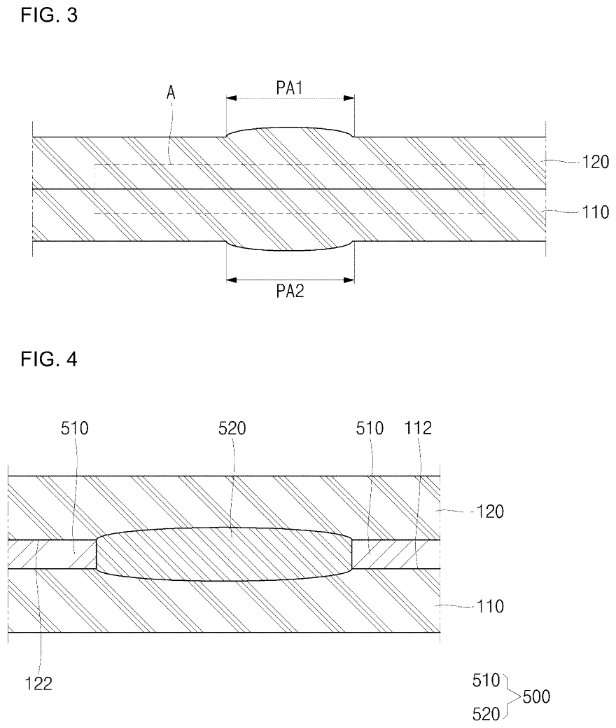

FIG. 2 is a detailed top view showing the secondary battery according to an embodiment. FIG. 3 is a sectional view taken along line A-A′ of FIG. 2, and FIG. 4 is an enlarged view showing region A of FIG. 3.

Referring to FIGS. 2 to 4, the secondary battery may include a vent 150. For example, the secondary battery may include at least one vent 150. The vent 150 may be disposed on a side surface of the secondary battery. The vent 150 may be formed in the sealing layer 500. In detail, the vent 150 may be opened by melting of the sealing layer 500.

In detail, the case 100 may be divided into a plurality of sealing parts. For example, referring to FIG. 2, the case 100 may include a first sealing part SA1, a second sealing part SA2, and a third sealing part SA3. The first sealing part SA1 may be a part where the lead 300 is bonded. That is, the first sealing part SA1 may be a short-side sealing part of the case 100. The second sealing part SA2 and the third sealing part SA3 may be side sealing parts of the case 100. That is, the second sealing part SA2 and the third sealing part SA3 may be long-side sealing parts of the case 100. The vent 150 may be formed in at least one sealing part among the second sealing part SA2 and the third sealing part SA3.

The accommodation part 110 and the cap part 120 may be bonded by the sealing layer 500. In detail, the sealing layer 500 may be disposed between the first sealing region 112 and the second sealing region 122. Accordingly, moisture or impurities may be prevented from flowing into the interior of the case 100.

The case 100 may include a convex part. The convex part may include a first convex part PA1 and a second convex part PA2. Referring to FIGS. 1 and 3, the first convex part PA1 may be disposed on the first sealing region 112 of the accommodation part 110, and the second convex part PA2 may be disposed on the second sealing region 122 of the cap part 120. The first convex part PA1 and the second convex part PA2 may face each other. The first convex part PA1 and the second convex part PA2 may be formed by a second sealing layer.

Referring to FIG. 4, the sealing layer 500 may include a first sealing layer 510 and a second sealing layer 520. The first sealing layer 510 and the second sealing layer 520 may include the same or different materials.

The first sealing layer 510 and the second sealing layer 520 may be formed in different ways. In detail, before bonding the first and second sealing regions 112 and 122, a sealing film may be disposed in some regions (e.g., only some regions) between the first and second sealing regions 112 and 122. The second sealing layer 520 may be formed by the sealing film. Next, a sealing material may be applied on a region excluding the sealing film. The first sealing layer 510 may be formed by the sealing material.

Next, heat may be applied to the sealing film and the sealing material, e.g., the sealing film and the sealing material may be different materials or in different phases. Accordingly, the first sealing layer 510 and the second sealing layer 520 may be disposed between the first and second sealing regions 112 and 122. Since the sealing layers are formed using materials of different phases, the first sealing layer 510 and the second sealing layer 520 may form a step, e.g., upper surfaces of the first and second sealing layers 510 and 520 may be at different levels to form a step and/or lower surfaces of the first and second sealing layers 510 and 520 may be at different levels to form a step. Accordingly, the first convex part PA1 and the second convex part PA2 may be formed on the region where the second sealing layer 520 is disposed, e.g., so each of the first convex part PA1 and the second convex part PA2 may be convex (e.g., curve out or bulge out) relative to the first sealing layer 510.

Therefore, a user of the secondary battery may check whether the vent is formed by the convex part. For example, since the vent 150 may be formed in the convex part, which is visible from outside the case 100 (e.g., due to bulging out relative to remainders of the first and second sealing regions 112 and 122), the potential presence of the vent 150 may be confirmed in advance by a user via the presence of the convex part.

The first sealing layer 510 and the second sealing layer 520 may have different physical characteristics. For example, the melting points of the first sealing layer 510 and the second sealing layer 520 may be different. In detail, the melting point of the second sealing layer 520 may be lower than the melting point of the first sealing layer 510. For example, the first sealing layer 510 and the second sealing layer 520 may include materials having different melting points. In another example, the first sealing layer 510 and the second sealing layer 520 may include the same material, and one of the first sealing layer 510 and the second sealing layer 520 may include an additive changing the melting point.

For example, the melting temperature of the first sealing layer 510 may be 130° C. to 140° C. For example, the first sealing layer 510 may include polypropylene. In another example, the first sealing layer 510 may include various resins having a melting temperature in the above range, e.g., in a temperature range of 130° C. to 140° C. The melting temperature of the second sealing layer 520 may be 90° C. to 110° C. For example, the second sealing layer 520 may include at least one of polyethylene (LDPE), polystyrene (PS), and ethylene-vinyl acetate copolymer (EVA). In another example, the second sealing layer 520 may include various resins having a melting temperature in the above range, e.g., in a temperature range of 90° C. to 110° C.

Therefore, when the internal temperature of the case 100 increases, the second sealing layer 520 may melt earlier than the first sealing layer 510. Therefore, when the internal temperature of the case 100 increases, an opening may be formed in the sealing layer 500 (i.e., in the second sealing layer 520). Accordingly, high-temperature gas in the case 100 may be discharged through the opening. Therefore, when an event of the secondary battery occurs, a fire may be prevented from occurring in the secondary battery.

The secondary battery according to the embodiment may include the vent 150 formed on the sealing region. The vent 150 may be opened by melting of the second sealing layer 520, so the secondary battery may maintain the adhesive characteristics and sealing characteristics of the case 100 by the first sealing layer 510, while the vent 150 may be opened within a set temperature range by the second sealing layer 520.

Accordingly, when an event of the secondary battery occurs, a fire occurring in the secondary battery may be substantially reduced or prevented. In addition, the vent 150 may be formed in the sealing layer 500, so a process of forming a separate vent in the case 100 may be omitted, thereby improving the strength of the case 100 and process efficiency.

Also, the secondary battery may include a convex part that is visible to a user from the outside, so the user may check whether the vent is formed without checking the sealing layer separately. Accordingly, the user may easily check whether the vent is formed by checking only the appearance of the secondary battery. Accordingly, the user may use various secondary batteries depending on the usage environment of the secondary battery.

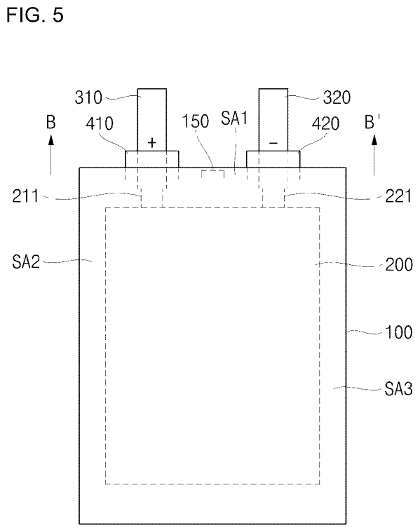

Hereinafter, the secondary battery according to another embodiment will be described with reference to FIGS. 5 to 9.

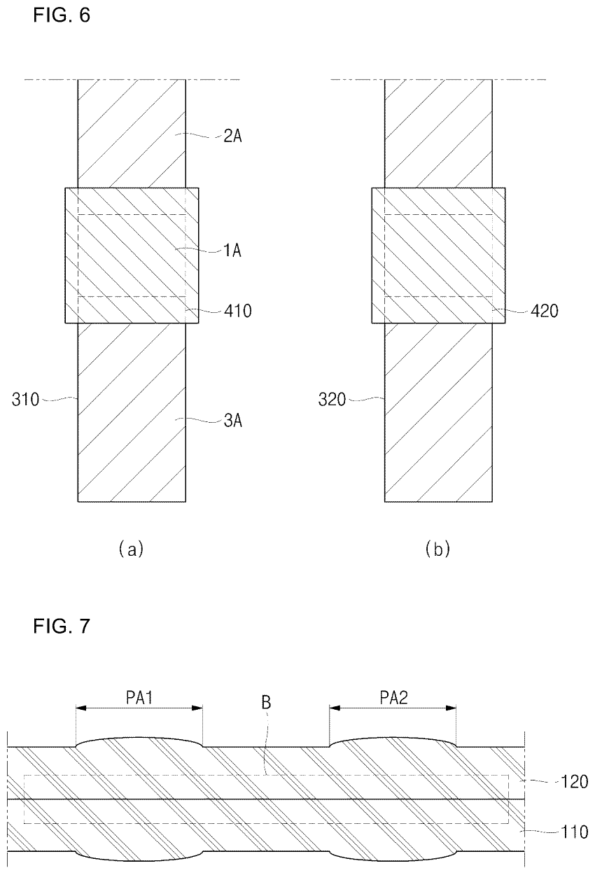

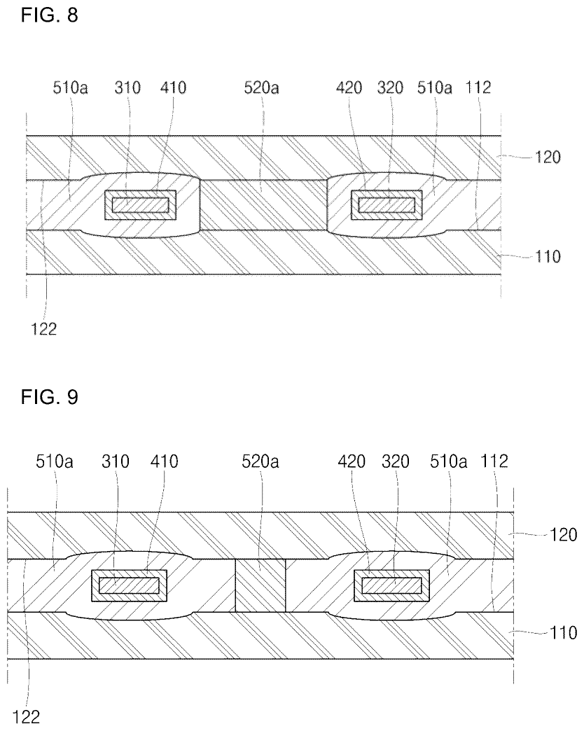

FIG. 5 is another top view showing a secondary battery according to an embodiment, and FIG. 6 is a top view showing a lead of a secondary battery according to an embodiment. FIG. 7 is a sectional view taken along line B-B′ of FIG. 5, and FIGS. 8 and 9 are enlarged views showing region B of FIG. 7.

Referring to FIGS. 5 to 9, the secondary battery may include the vent 150. For example, the secondary battery may include at least one vent 150. The vent 150 may be disposed on the side surface of the secondary battery. The vent 150 may be formed in the first sealing part SA1. For example, the vent 150 may be disposed between the electrode tabs. The vent 150 may be opened by melting of a sealing layer 500a.

FIG. 6 is a drawing explaining that an insulating layer 400 is disposed on the lead 300. Referring to FIG. 6, the insulating layer 400 may be disposed on a partial region of the lead 300. The lead 300 may be divided into a plurality of regions. For example, the lead 300 may include a first region 1A, a second region 2A, and a third region 3A.

The first region 1A may overlap the case 100. In detail, the first region 1A may overlap (e.g., at least partially overlap) the sealing regions 112 and 122. The second region 2A may be disposed in the case 100. The third region 3A may be disposed outside the case 100.

The insulating layer 400 may be disposed on the first region 1A, the second region 2A, and the third region 3A. In detail, the insulating layer 400 may cover the entire region of the first region 1A, and may be disposed on a partial region of the second region 2A and a partial region of the third region 3A.

Accordingly, the insulating layer 400 may be disposed to completely cover the first region 1A. Accordingly, the lead 300 and the case 100 may not be in contact with each other due to the insulating layer 400.

The accommodation part 110 and the cap part 120 may be bonded by the sealing layer 500. In detail, the sealing layer 500a may be disposed between the first sealing region 112 and the second sealing region 122. Accordingly, moisture or impurities may be prevented from flowing into the interior of the case 100.

The sealing layer 500a may include a first sealing sub-layer 510a and a second sealing sub-layer 520a. The first sealing sub-layer 510a and the second sealing sub-layer 520a may include the same or different materials.

The first sealing sub-layer 510a and the second sealing sub-layer 520a may have different physical characteristics. For example, the melting points of the first sealing sub-layer 510a and the second sealing sub-layer 520a may be different. In detail, the melting point of the second sealing sub-layer 520a may be lower than the melting point of the first sealing sub-layer 510a. For example, the first sealing sub-layer 510a and the second sealing sub-layer 520a may include materials having different melting points. In another example, the first sealing sub-layer 510a and the second sealing sub-layer 520a may include the same material, and one of the first sealing sub-layer 510a and the second sealing sub-layer 520a may include an additive that changes the melting point.

For example, the melting temperature of the first sealing sub-layer 510a may be 130° C. to 140° C. For example, the first sealing sub-layer 510a may include polypropylene. In another example, the first sealing sub-layer 510a may include various resins having a melting temperature within the above range. The melting temperature of the second sealing sub-layer 520a may be 90° C. to 110° C. For example, the second sealing sub-layer 520a may include at least one of polyethylene (LDPE), polystyrene (PS), and ethylene-vinyl acetate copolymer (EVA). In another example, the second sealing sub-layer 520a may include various resins having a melting temperature within the above range.

Therefore, when the internal temperature of the case 100 increases, the second sealing sub-layer 520a may melt earlier than the first sealing sub-layer 510a. Therefore, when the internal temperature of the case 100 increases, an opening may be formed in the sealing layer 500a. Accordingly, high-temperature gas in the case may be discharged through the opening. Therefore, when an event of the secondary battery occurs, a fire may be prevented from occurring in the secondary battery.

The second sealing sub-layer 520a may be disposed at a set position. For example, the second sealing sub-layer 520a may be disposed in a region between the leads 300. For example, referring to FIG. 8, the second sealing sub-layer 520a may be disposed in an entire region of the region between the first and second leads 310 and 320. In another example, referring to FIG. 9, the second sealing sub-layer 520a may be disposed in a partial region between the first and second leads 310 and 320.

A space for disposing the electrode tab may be formed between the junction of the lead and the case and the electrode assembly. Accordingly, a high-temperature gas generated by an increase in the temperature of the secondary battery may be concentrated between the junction and the electrode assembly. The second sealing sub-layer 520a may be disposed in the region between the leads. Accordingly, the second sealing sub-layer 520a may be easily opened by the high-temperature gas. Accordingly, the gas may be discharged to the outside of the secondary battery. Accordingly, the fire of the secondary battery may be prevented or reduced.

The secondary battery according to another embodiment may include the vent 150 formed on the sealing region. The vent may be opened by melting of the second sealing sub-layer 520a. Accordingly, the secondary battery may maintain the adhesive characteristics and sealing characteristics of the case by the first sealing sub-layer 510a, and the vent 150 may be opened within a set temperature range by the second sealing sub-layer 520a.

Accordingly, when an event of the secondary battery occurs, a fire may be substantially reduced or prevented from occurring in the secondary battery. Also, the vent may be formed in the sealing layer, thereby a process of forming a separate vent in the case may be omitted, which in turn, may improve the strength of the case and process efficiency. In addition, the vent may be disposed in the region between the leads, thereby easily allowing melting of the second sealing sub-layer by gas generated in the secondary battery and gas discharge by the open vent.

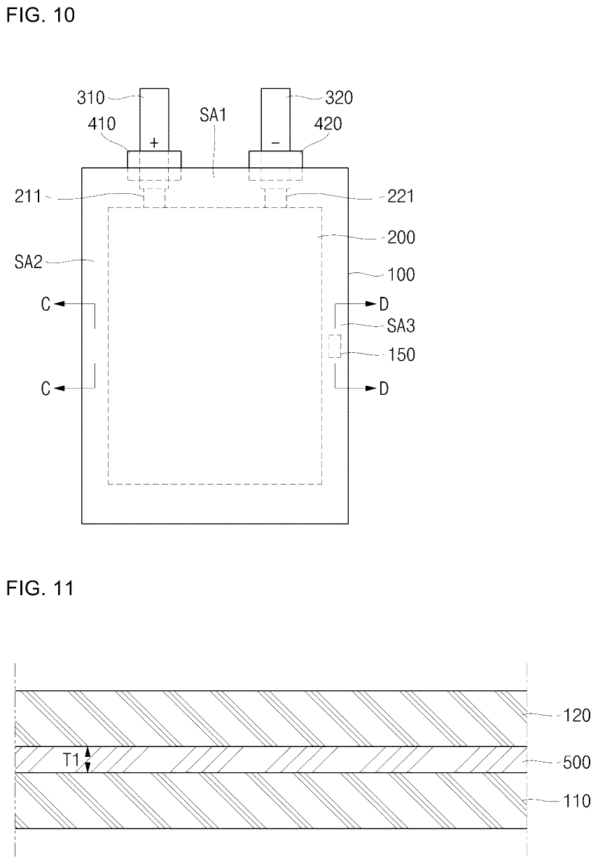

Hereinafter, a secondary battery according to another embodiment will be described with reference to FIGS. 10 to 12.

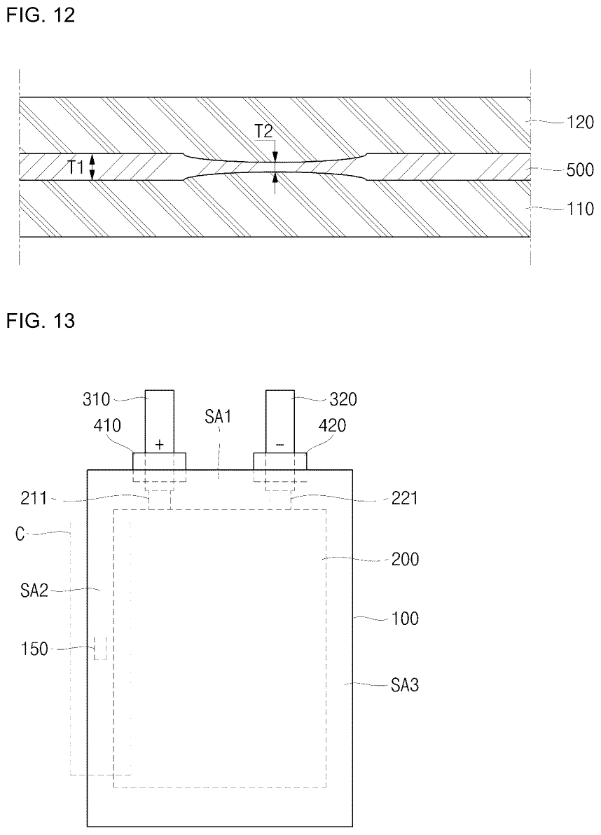

FIG. 10 is another top view showing a secondary battery according to an embodiment. FIG. 11 is a sectional view taken along line C-C′ of FIG. 10, and FIG. 12 is a sectional view taken along line D-D′ of FIG. 10.

Referring to FIGS. 10 to 12, the secondary battery may include the vent 150. For example, the secondary battery may include at least one vent 150. The vent 150 may be disposed on the side surface of the secondary battery. In detail, the vent 150 may be opened by melting or breaking the sealing layer 500. The vent 150 may be formed in the second sealing part SA2 or the third sealing part SA3.

In detail, the accommodation part 110 and the cap part 120 may be bonded by the sealing layer 500. In detail, the sealing layer 500 may be disposed between the first sealing region 112 and the second sealing region 122. Accordingly, moisture or impurities may be prevented from flowing into the interior of the case.

The thicknesses of the sealing layers of the second sealing part SA2 and the third sealing part SA3 may be different. For example, referring to FIG. 11, the sealing layer 500 in the second sealing part SA2 may have a constant thickness (e.g., a first thickness T1). Referring to FIG. 12, the sealing layer 500 in the third sealing part SA3 may have a varying thickness (e.g., the first thickness T1 and a second thickness T2). The first thickness T1 and the second thickness T2 may be different from each other. For example, the second thickness T2 may be smaller than the first thickness T1.

That is, the third sealing part SA3 may include a portion of the sealing layer 500 that has a small thickness. The thickness of the sealing layer 500 may be controlled during the process of forming the sealing layer. For example, the sealing layer 500 may be formed by thermal compression. In this case, the pressure applied to some regions of the third sealing part SA3 may be greater than the pressure applied to other regions.

Accordingly, the third sealing part SA3 may include portions of the sealing layer 500 having different thicknesses from each other.

When the internal temperature and the internal pressure of the secondary battery increase, a portion of the sealing layer 500 having the second thickness T2 may be easily broken. That is, a portion of the sealing layer 500 having a small thickness may be easily opened by the internal pressure and internal temperature. Accordingly, the gas in the secondary battery may be easily discharged through the vent 150.

The secondary battery according to another embodiment includes the vent 150 formed on the sealing region. The vent 150 may be formed in a portion of the sealing layer 500 having a small thickness. The vent may be opened by melting or breaking of the portion of the sealing layer 500 having a small thickness.

Accordingly, the vent 150 of the secondary battery may be opened within a set temperature range. Accordingly, when an event of the secondary battery occurs, a fire may be substantially reduced or prevented from occurring in the secondary battery. Also, the vent 150 may be formed in the sealing layer 500, thereby a process of forming a separate vent in the case may be omitted, which in turn, may improve the strength of the case and the process efficiency.

In addition, the vent 150 may be formed by controlling the thickness of the sealing layer 500. Accordingly, the vent 150 may be formed without disposing a separate additional sealing layer 500 (e.g., the entire sealing layer 500 may be formed of a same material), and the vent 150 may be formed during a process of thermally compressing the sealing layer 500. Accordingly, a separate process of forming the vent 150 is not required.

Hereinafter, the secondary battery according to another embodiment will be described with reference to FIGS. 13 to 18.

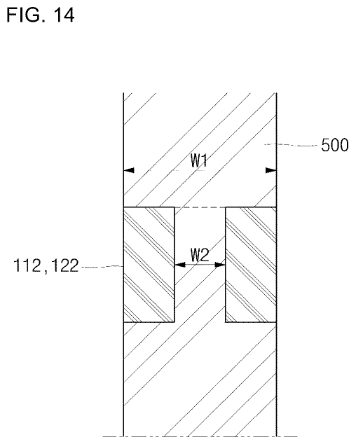

FIG. 13 is another top view showing a secondary battery according to an embodiment. FIGS. 14 to 18 are views explaining a sealing layer on a region C of FIG. 13.

Referring to FIGS. 13 to 18, the secondary battery may include the vent 150. For example, the secondary battery may include at least one vent 150. The vent 150 may be disposed on the side surface of the secondary battery. In detail, the vent 150 may be opened by melting or breaking of the sealing layer 500. The vent 150 may be formed in at least one of the second sealing part SA2 or the third sealing part SA3.

The accommodation part 110 and the cap part 120 may be bonded by the sealing layer 500. In detail, the sealing layer 500 may be disposed between the first sealing region 112 and the second sealing region 122. Accordingly, moisture or impurities may be prevented from flowing into the interior of the case.

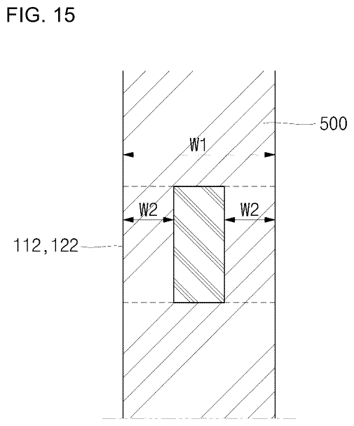

The sealing layer 500 may include regions having different widths. For example, referring to FIGS. 14 and 15, the sealing layer 500 may include a region having a first width W1 and a region having a second width W2 (e.g., as viewed in a top view looking toward the sealing layer 500 covering portions of the first sealing region 112). The first width W1 and the second width W2 may be different from each other. For example, the second width W2 may be smaller than the first width W1.

For example, referring to FIG. 14, the region having the second width W2 may be disposed in a central region of the first and second sealing regions 112 and 122 or a region adjacent to the central region. Referring to FIG. 15, the region having the second width W2 may be disposed along the edge region of the first and second sealing regions 112 and 122.

When the internal temperature and internal pressure of the secondary battery increase, the sealing layer 500 having the second width W2 may be easily broken. That is, the sealing layer 500 having a small width may be easily opened by the internal pressure and internal temperature. Accordingly, gas inside the secondary battery may be easily discharged through the vent 150.

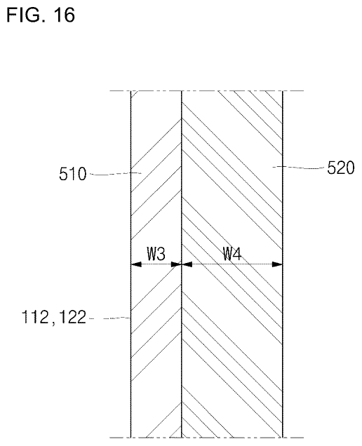

Referring to FIG. 16, the sealing layer may include the first sealing layer 510 and the second sealing layer 520. The first sealing layer 510 and the second sealing layer 520 may be disposed at set positions. The first sealing layer 510 may be disposed on the outside of the sealing region, and the second sealing layer 520 may be disposed on the inside of the sealing region. That is, the second sealing layer 520 may be disposed closer to the electrode assembly 200 than the first sealing layer 510.

As described above, the melting points of the first sealing layer 510 and the second sealing layer 520 may be different from each other. That is, the melting point of the second sealing layer 520 may be lower than the melting point of the first sealing layer 510.

Accordingly, the second sealing layer 520 may melt earlier than the first sealing layer 510. Therefore, when the event of the secondary battery occurs, the second sealing layer 520 is melted first. The first sealing layer 510 may be disposed in only a portion of the sealing region. Therefore, the first sealing layer 510 may be easily broken and melted by the internal pressure and internal temperature of the secondary battery. Therefore, the vent may be opened by the melting and breaking of the sealing layers. Accordingly, the gas in the secondary battery may be discharged through the vent.

The width W3 of the first sealing layer 510 and the width W4 of the second sealing layer 520 may be the same or different. For example, the width W3 of the first sealing layer 510 and the width W4 of the second sealing layer 520 may be different from each other. The width W4 of the second sealing layer 520 may be larger than the width W3 of the first sealing layer 510. Accordingly, the vent may be easily opened. In detail, when the event of the secondary battery occurs, the second sealing layer 520 may be melted by high-temperature gas. Next, the first sealing layer 510 may be broken. The width of the first sealing layer 510 is small. Therefore, the first sealing layer 510 may be easily broken by the internal pressure. Accordingly, the gas in the secondary battery may be discharged through the vent.

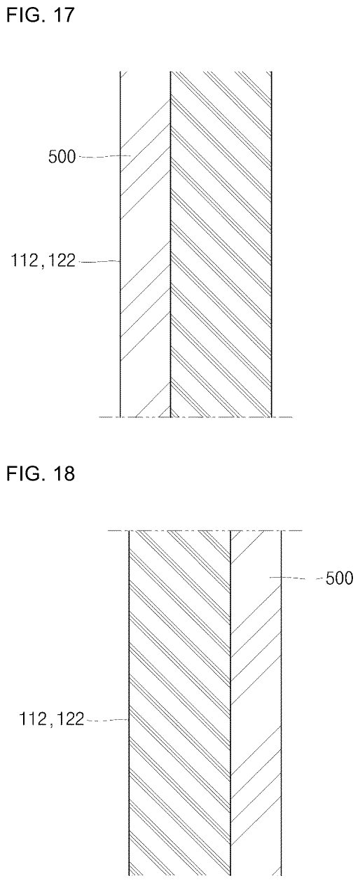

Referring to FIGS. 17 and 18, the sealing layer 500 may be disposed only at one edge of the sealing region. For example, referring to FIG. 17, the sealing layer 500 may be disposed only on the outer edge of the sealing region. In another example, referring to FIG. 18, the sealing layer 500 may be disposed only on the inner edge of the sealing region.

The width of the sealing layer may be 50% or more of the total width of the sealing region. If the width of the sealing layer is less than 50% of the width of the sealing region, the bonding characteristics of the accommodation part and the cap part may decrease.

The sealing layer 500 may be formed only on a part of the sealing region. In detail, the sealing layer 500 may be formed with a sufficient width that can bond the accommodation part and the cap part. Accordingly, when the event of the secondary battery occurs, the sealing layer may be easily broken and melted. Accordingly, the vent may be opened. Accordingly, high-temperature gas may be easily discharged through the vent.

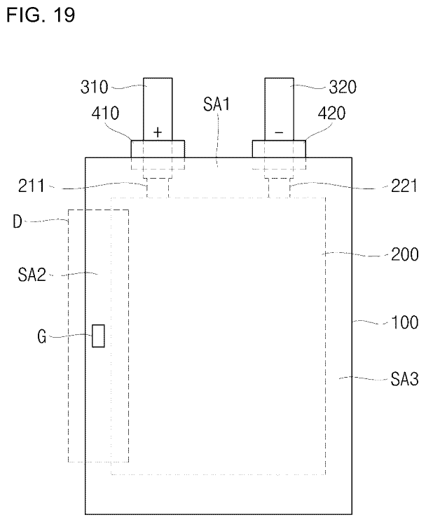

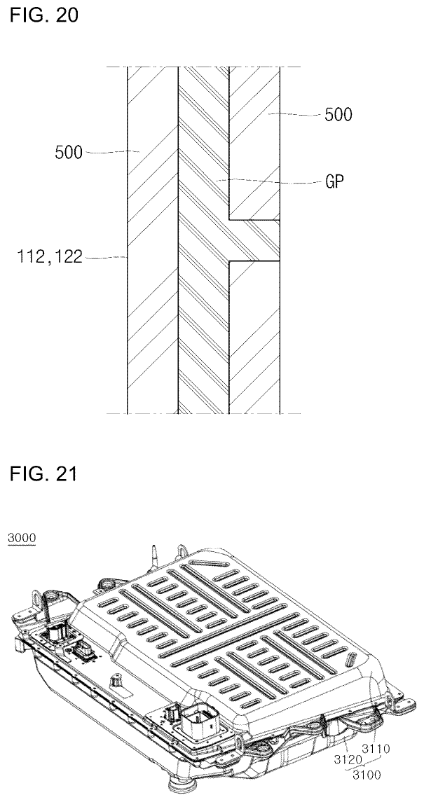

Hereinafter, the secondary battery according to another embodiment will be described with reference to FIGS. 19 and 20.

FIG. 19 is another top view showing a secondary battery according to an embodiment. FIG. 20 is a view explaining a sealing layer on a region D of FIG. 19.

Referring to FIGS. 19 and 20, the secondary battery may include the vent. For example, the case may include a groove G. The groove G may be disposed in at least one of the first sealing part SA1, the second sealing part SA2, or the third sealing part SA3. The groove G may be formed in a portion of the sealing region. The groove G may be formed in at least one of the accommodation part 110 or the cap part 120. The groove G may be the vent.

The sealing layer 500 may be formed in only a portion of the sealing region. Accordingly, the gas movement passage GP may be formed in the sealing region. The gas movement passage GP may extend along the longitudinal direction of the sealing part. The gas movement passage GP may be connected to the concave part 111. The gas movement passage GP may overlap with the groove G. In detail, a portion of the gas movement passage GP may overlap with the groove G.

Accordingly, when the event of the secondary battery occurs, high-temperature gas may move along the gas movement passage GP. Accordingly, the internal pressure of the gas movement passage GP may increase. Accordingly, the groove G may be broken. Accordingly, the vent may be opened. Accordingly, the gas of the gas movement passage GP may be discharged through the vent.

The secondary battery described above may constitute a battery module. For example, the battery module may include a plurality of secondary batteries. Multiple secondary batteries may be connected to each other in series, parallel, or series/parallel via busbars.

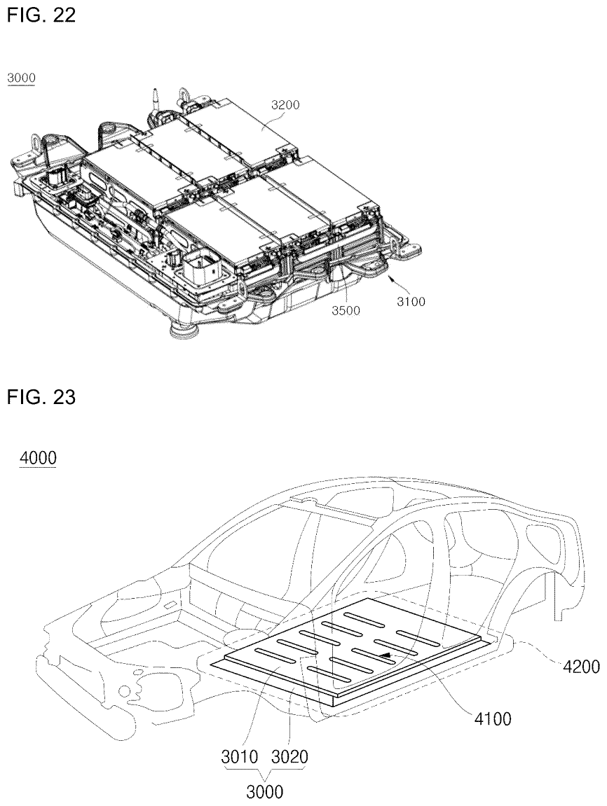

FIGS. 21 and 22 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 23, a battery pack 3000 may include a battery pack cover 3010, which is a part of a vehicle underbody 4100 and may correspond to the first housing, and a pack frame 3020, which is disposed under the vehicle underbody 4100 and may correspond to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

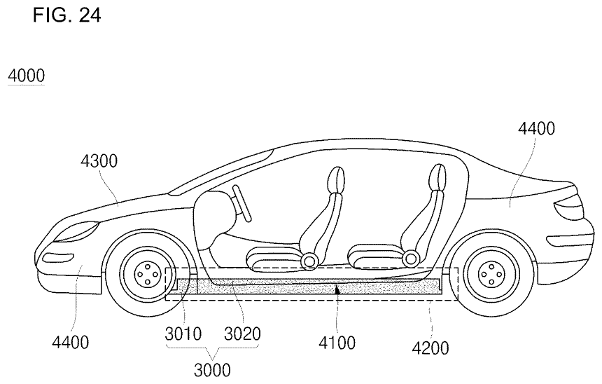

In FIG. 24, the vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a case comprising an accommodation part and a cap part, the accommodation part and the cap part being bonded by a sealing layer on a sealing part, the sealing layer comprising a first sealing layer and a second sealing layer, and a melting temperature of the second sealing layer being lower than a melting temperature of the first sealing layer;
an electrode assembly accommodated in the accommodation part;
a plurality of electrode tabs connected to the electrode assembly; and
a plurality of leads connected to the plurality of electrode tabs.

2. The secondary battery as claimed in claim 1, wherein:
the sealing part comprises a first sealing part, a second sealing part, and a third sealing part,
the plurality of leads are on the first sealing part, and
at least one of the second sealing part and the third sealing part comprises the first sealing layer and the second sealing layer.

3. The secondary battery as claimed in claim 2, wherein the case comprises a convex part, the convex part being arranged on a region corresponding to the second sealing layer.

4. The secondary battery as claimed in claim 1, wherein:
the sealing part comprises a first sealing part, a second sealing part, and a third sealing part,
the plurality of leads are on the first sealing part, and
the first sealing part comprises the first sealing layer and the second sealing layer.

5. The secondary battery as claimed in claim 4, wherein the second sealing layer is between the plurality of leads.

6. The secondary battery as claimed in claim 4, wherein the second sealing layer is in an entire region between the plurality of leads.

7. The secondary battery as claimed in claim 4, wherein the second sealing layer is only in a portion of a region between the plurality of leads.

8. The secondary battery as claimed in claim 1, wherein the first sealing layer and the second sealing layer have different physical characteristics.

9. The secondary battery as claimed in claim 1, wherein the second sealing layer comprises a sealing film.

10. The secondary battery as claimed in claim 1, wherein:
the melting temperature of the first sealing layer is 130 °C to 140 °C, and
the melting temperature of the second sealing layer is 90 °C to 110 °C.

11. The secondary battery as claimed in claim 1, wherein the first sealing layer and the second sealing layer comprise a same material.

12. The secondary battery as claimed in claim 1, wherein the first sealing layer and the second sealing layer comprise different materials.

13. A secondary battery, comprising:
a case comprising an accommodation part and a cap part bonded by a sealing layer on a sealing region, the sealing layer comprising sealing parts, and at least one of the sealing parts comprising sealing sub-layers having different thicknesses from each other;
an electrode assembly accommodated in the accommodation part;
a plurality of electrode tabs connected to the electrode assembly; and
a plurality of leads connected to the plurality of electrode tabs.

14. The secondary battery as claimed in claim 13, wherein:
the at least one of the sealing parts comprises a first sealing part, a second sealing part, and a third sealing part,
the plurality of leads are on the first sealing part, and
at least one of the second sealing part and the third sealing part comprises the sealing sub-layers.

15. The secondary battery as claimed in claim 14, wherein:
the second sealing part comprises a first sealing sub-layer having a first thickness,
the third sealing part comprises a second sealing sub-layer having a first portion with the first thickness and a second portion with a second thickness, and
the second thickness is smaller than the first thickness.

16. A secondary battery, comprising:
a case comprising an accommodation part and a cap part bonded by a sealing layer on a sealing region, the sealing layer comprising sealing parts, and at least one of the sealing parts comprising a sealing sub-layer having a width smaller than a width of the sealing region;
an electrode assembly accommodated in the accommodation part;
a plurality of electrode tabs connected to the electrode assembly; and
a plurality of leads connected to the plurality of electrode tabs.

17. The secondary battery as claimed in claim 16, wherein:
the sealing parts comprise a first sealing part, a second sealing part, and a third sealing part,
the plurality of leads are on the first sealing part, and
at least one of the second sealing part and the third sealing part comprises the sealing sub-layer.

18. The secondary battery as claimed in claim 17, wherein the sealing sub-layer comprises a region having a first width and a region having a second width, the second width being smaller than the first width.

19. The secondary battery as claimed in claim 18, wherein a portion of the sealing sub-layer having the second width is in a central region or at an edge region of the sealing region.

20. The secondary battery as claimed in claim 16, wherein:
the sealing parts comprise a first sealing part, a second sealing part, and a third sealing part,
the plurality of leads are on the first sealing part,
at least one of the second sealing part and the third sealing part comprises the sealing sub-layer disposed at an edge region of the sealing region, and
the width of the sealing sub-layer is 50% or more of the width of the sealing region.
